(19) United States
(12) Patent Application Publication
(10) Pub. No.: US 2003/0197082 A1
(43) Pub. Date: Oct. 23, 2003

(54) Magnetic tape drive for preventing a flange spacer from being stripped off

(75) Inventor: Kenichi Ojima, Yamagata (JP)

Correspondence Address: YOUNG & THOMPSON, 745 SOUTH 23RD STREET 2ND FLOOR, ARLINGTON, VA, 22202

(73) Assignee: NEC CORPORATION

(21) Appl. No.: 10/409,195

(22) Filed: Apr. 9, 2003

(30) Foreign Application Priority Data
Apr. 17, 2002 (JP) 2002-114858

(51) Int. Cl. G11B 15/67; G11B 23/107

(52) U.S. Cl. 242/332.4; 242/348.2

(57) ABSTRACT

A magnetic tape drive prevents a flange spacer from being stripped off. The drive holds a leader pin provided on a head end of a magnetic tape stored in a medium. The drive includes an arm arranged to be rotatable about an axis and positioned so that the arm can draw out said magnetic tape from the medium by engaging the leader pin and rotating, a base to which the arm is rotatably attached, and the flange spacer arranged between the arm and the base. The flange surrounds the axis about which the arm is rotatable.

### BACKGROUND OF THE INVENTION

The present invention relates to a magnetic tape drive, and more particularly, to a magnetic tape drive for writing data or reading recorded data by a magnetic head.

Normally, a magnetic tape drive draws out a magnetic tape from a medium, and writes data or reads recorded data on the magnetic tape by a magnetic head. After the magnetic tape drive has performed a data writing operation and the like, it reels in and stores the magnetic tape into the medium.

It should be noted that an operation of moving a leader block provided on a head end of a magnetic tape from a medium in a state where the leader block is held by an arm being attachable to and detachable from the leader block at the time of drawing out the magnetic tape and thereby drawing out the magnetic tape from the medium and fixing it on a take-up reel is referred to as “threading”. On the other hand, an operation of moving the arm in the opposite direction to the direction of “threading” and storing the magnetic tape fixed on the take-up reel into the medium is referred to as “unthreading”.

Referring to FIG. 4(a) and FIG. 4(b), in a conventional magnetic tape drive, an arm motor 7 is fixed on a base 1. The arm motor 7 has an arm 2 which turns round an axis of the arm motor 7. The arm 2 has an arm pin 2b fixed to it. The arm pin 2b has a leader block 2a which travels around the arm axis along an arm pin locus 4.

A take-up reel 6 and a guide roller 10 are attached to the base 1. A medium 5 is set on the base 1 by a separate manual or automatic mechanism. A leader pin 5a is fixed to the head end of a magnetic tape 5b of the medium 5.

The base 1 and a base contact face 1a are formed into one body. Flange spacers 8 and 9 for positioning the bottom face of the arm 2 are stuck to the base contact face 1a so as to prevent wear powder from being generated by friction between the arm 2 and the base contact face 1a.

In operation, referring to FIG. 5(a), first, when the medium 5 is set on the base 1, the leader block 2a waiting at position “A” is engaged with the leader pin 5a on the head end of the magnetic tape 5b.

After this, the arm motor 7 turns around the arm axis, and the arm pin 2b passes before the guide roller 10 (FIG. 5(b)) and moves along the arm pin locus 4, drawing the arm pin locus 4 from position “A” toward position “B” (FIG. 5(c)).

Then, referring to FIG. 5(d), the magnetic tape 5b is fixed to the take-up reel 6 at position “B”.

However, the prior art has a problem. Referring to FIG. 5(b), there is space between the flange spacers 8 and 9 on the route of movement of the arm 2. Here, when there is a gap around the fulcrum of the arm 2, the arm2 is inclined downward by weight of the leader block 2a.

Due to this, as shown in FIG. 6, “threading” or “unthreading” of the arm 2 has been sometimes hindered by the fact that the arm 2 is caught by a side face of the flange spacer 9 and the flange spacer 9 is stripped off from the base contact face 1a.

### SUMMARY OF THE INVENTION

The present invention has an object to provide a magnetic tape drive for preventing a flange spacer from being stripped off.

According to one embodiment of the present invention, a magnetic tape drive holds a leader pin provided on a head end of a magnetic tape stored in a medium. The drive includes an arm arranged to be rotatable about an axis and positioned so that the arm can draw out said magnetic tape from the medium by engaging the leader pin and rotating, a base to which the arm is rotatably attached, and a flange spacer arranged between the arm and the base. The flange surrounds the axis about which the arm is rotatable.

### BRIEF DESCRIPTION OF THE DRAWINGS

These and other objects, features and advantages of the invention will become more apparent from the following detailed description when taken in conjunction with the accompanying drawings, in which:

FIG. 1(a) is a plan view showing a schematic composition of a magnetic tape drive of an embodiment of the present invention;

FIG. 1(b) is a side view of the vicinity of an arm 2 of FIG. 1(a);

FIG. 2 is a side view of FIG. 3(b);

FIG. 3(a) is a diagram showing the movement of the arm 2 of FIG. 1(a);

FIG. 3(b) is a diagram showing the movement of the arm 2 of FIG. 1(a);

FIG. 3(c) is a diagram showing the movement of the arm 2 of FIG. 1(a);

FIG. 3(d) is a diagram showing the movement of the arm 2 of FIG. 1(a);

FIG. 4(a) is a plan view showing a schematic composition of a conventional magnetic tape drive;

FIG. 4(b) is a side view of the vicinity of an arm of FIG. 4(a);

FIG. 5(a) is a diagram showing the movement of an arm 2 of FIG. 4(a);

FIG. 5(b) is a diagram showing the movement of an arm 2 of FIG. 4(a);

FIG. 5(c) is a diagram showing the movement of an arm 2 of FIG. 4(a);

FIG. 5(d) is a diagram showing the movement of an arm 2 of FIG. 4(a);

FIG. 6 is side views showing states before and after FIG. 5(b); and

FIG. 7 is a plan view of the flange spacer 3 of FIG. 1

### DESCRIPTION OF THE PREFERRED EMBODIMENTS

The present invention will be now explained in detail below with reference to the accompanying drawings.

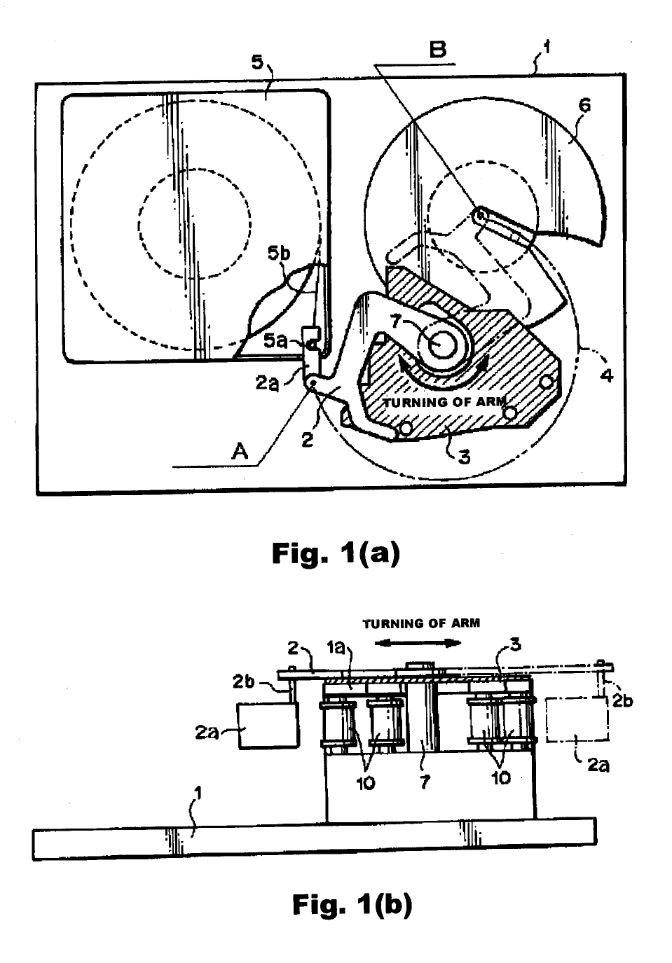

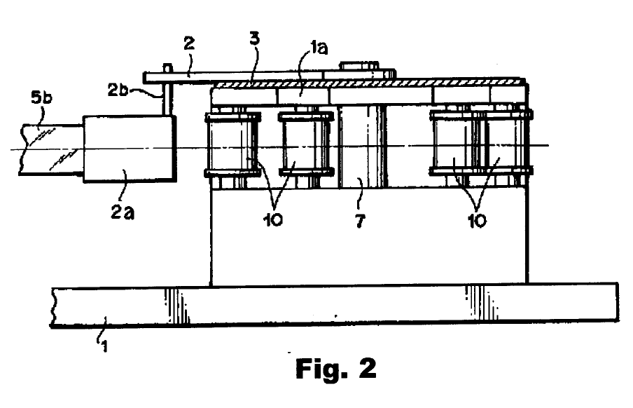

Referring to FIG. 1(a) and FIG. 1(b), in a magnetic tape drive of this embodiment, an arm motor 7 is fixed on a base 1. An arm 2, which rotates around an axis of the motor 7, is attached to the arm motor 7. An arm pin 2b is fixed to the arm 2. A leader block 2a, which travels around the arm axis along a locus 4 is fixed to the arm pin 2b.

A take-up reel 6 and a guide roller 10 are attached to the base 1. A medium 5 is set on the base 1 by a separate manual or automatic mechanism. A leader pin 5a is fixed to the head end of a magnetic tape 5b of the medium 5.

The base 1 and a base contact face 1a are formed into one body. A flange spacer 3 of a low-friction material is stuck to the base contact face 1a. The flange spacer 3 may be of a rigid material such as a metal plate material having such a low-friction material as fluorine applied to it. Alternatively, the flange spacer 3 may be replaced with two or more separate flange spacers.

Referring to FIG. 7, the flange spacer 3 has an edge rounded according to the shape of the base contact face 1a. Alternatively or in addition, the flange spacer may be made somewhat larger in size so as to cover the side face of the base contact face 1a. In such a case also, the flange spacer 3 may be replaced with two or more separate flange spacers. Because of this structure, the flange spacer 3 is difficult to delaminate from the base contact face 1a also in a process of manufacturing a magnetic tape drive.

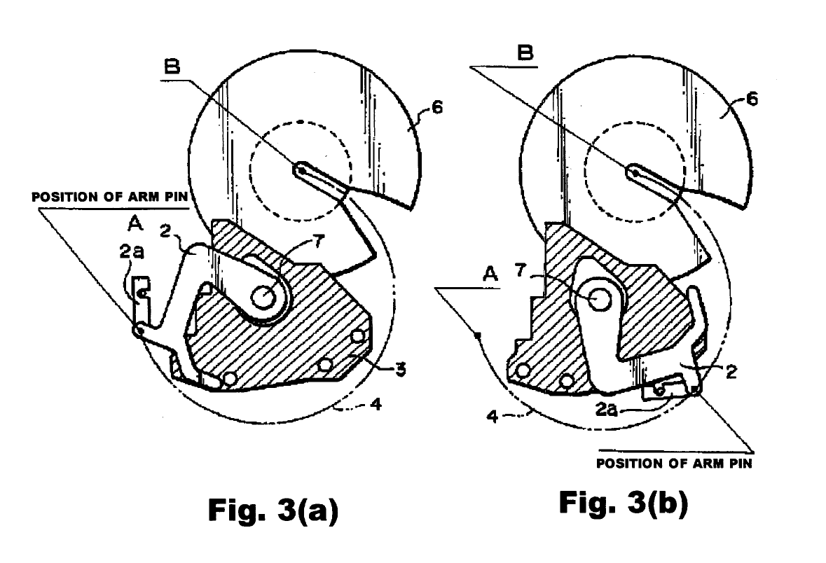

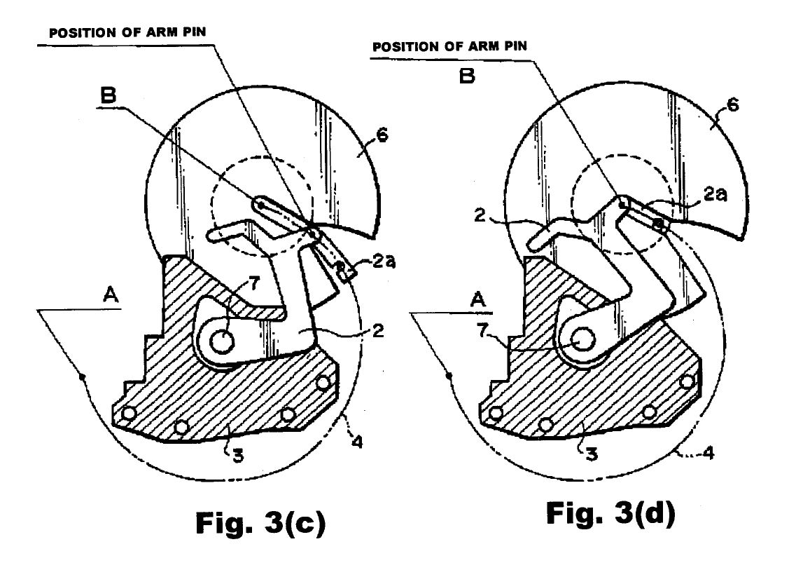

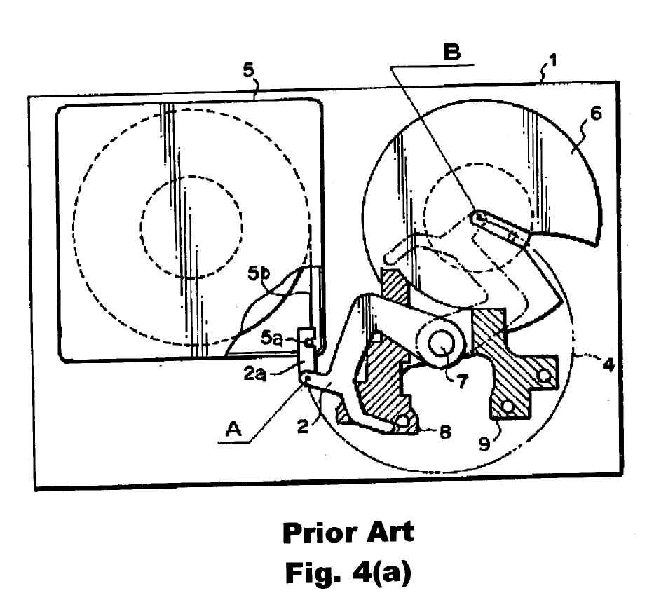

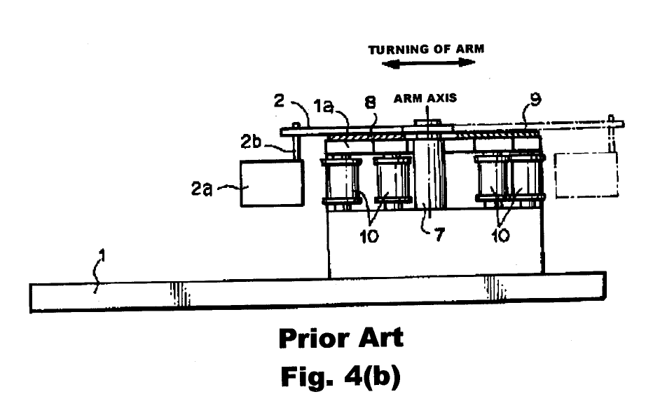

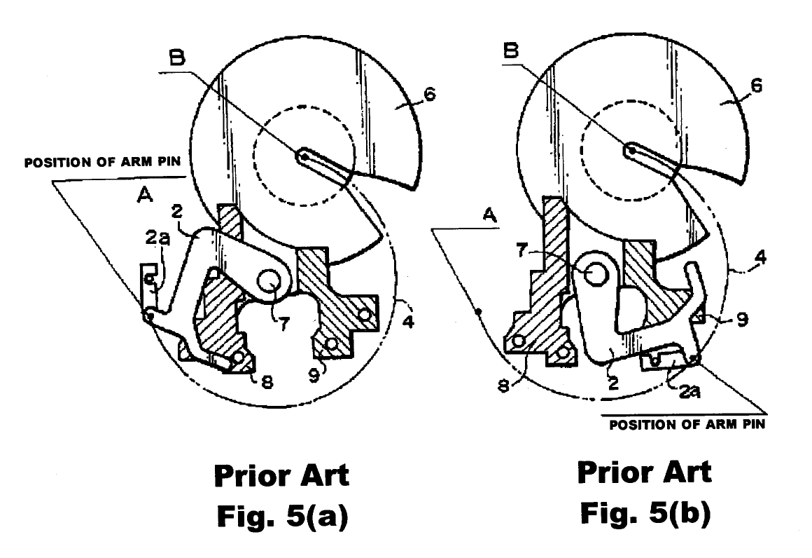

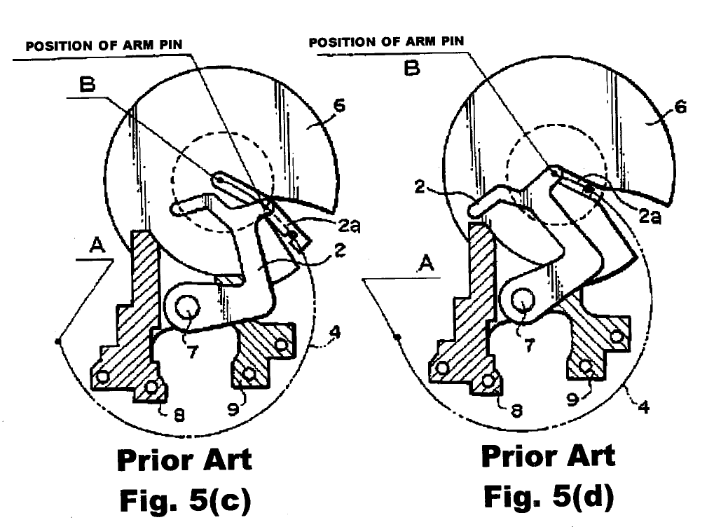

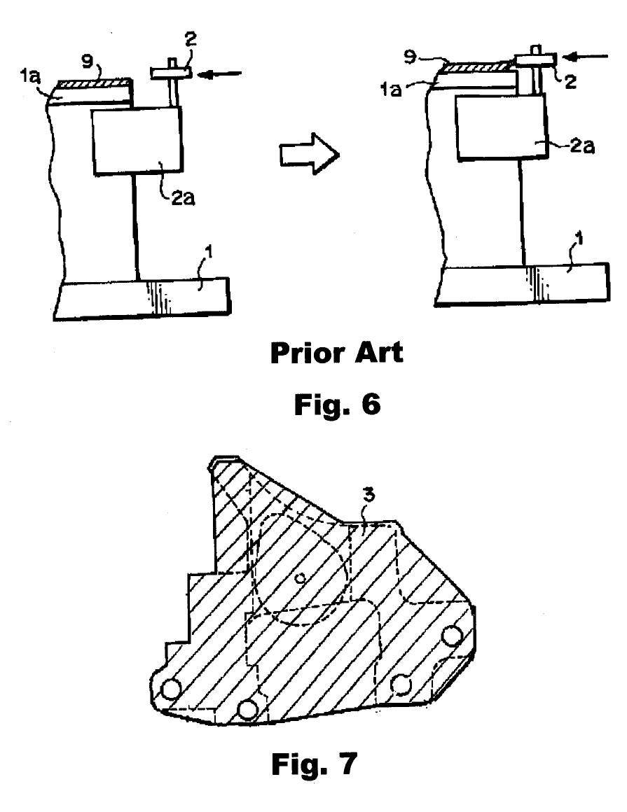

In operation, referring to FIG. 3(a), first, when the medium 5 is set to the base 1, the leader block 2a waiting at position “A” is engaged with the leader pin 5a on the head end of the magnetic tape 5b. After this, the arm motor 7 rotates around the axis, and the arm pin 2b passes before the guide roller 10 (FIG. 3(b)) and moves along the arm pin locus 4, drawing the leader block 2a from position “A” toward position “B” (FIG. 3(c)). Then, the magnetic tape 5b is fixed to the take-up reel 6 at position “B” (FIG. 3(d)).

The leader block 2a moves also from position “B” toward position “A” along the arm pin locus 4. A magnetic tape reeling motor (not shown) is attached to the medium 5 so as to prevent the magnetic tape drawn out from the medium 5 from loosening at this time.

As shown in FIG. 2, according to a fact that the flange spacer 3 is provided between the arm 2 and the base contact face 1a all along the route of movement of the arm 2, since the arm 2 moves between position “A” and position “B” while being in contact with the flange spacer 3, the arm 2 is prevented from being inclined downward due to weight of the leader block 2a.

As described above, since the arm 2 does not touch the side face of the flange spacer 3, the flange spacer 3 does not to delaminate from the base contact face 1a.

While this invention has been described in connection with the preferred embodiments described above, it will now be possible for those skilled in the art to put this invention into practice in various other manners.

What is claimed is:

1. A magnetic tape drive, which holds a leader pin provided on a head end of a magnetic tape stored in a medium, comprising:
an arm arranged to be rotatable about an axis and positioned so that the arm can draw out said magnetic tape from the medium by engaging the leader pin and rotating;
a base to which the arm is rotatably attached; and a flange spacer arranged between said arm and said base, wherein the flange surrounds the axis about which the arm is rotatable.

2. The magnetic tape drive of claim 1, wherein at least one edge of said flange spacer is rounded.

3. The magnetic tape drive of claim 1, wherein said flange spacer is of a low-friction material.

4. The magnetic tape drive of claim 1, wherein said flange spacer is of a rigid material having a low-friction material applied to it.

5. The magnetic tape drive of claim 4, wherein said low-friction material is fluorine.

6. A magnetic tape drive, which holds a leader pin provided on a head end of a magnetic tape stored in a medium, comprising:
an arm arranged to be rotatable about an axis and positioned so that the arm can draw out said magnetic tape from the medium by engaging the leader pin and rotating;
a base to which the arm is rotatably attached; and a flange spacer arranged between said arm and said base;
wherein at least one edge of said flange spacer is rounded.

7. The magnetic tape drive of claim 6, wherein said flange spacer is of a low-friction material.

8. The magnetic tape drive of claim 6, wherein said flange spacer is of a rigid material having a low-friction material applied to it.

9. The magnetic tape drive of claim 8, wherein said low-friction material is fluorine.

10. A system for positioning magnetic tape for reading and writing, comprising:
a magnetic tape arranged in a roll within a medium, a head end of the tape comprising a leader pin;
a base constructed and arranged to engage the medium;
an arm rotatably attached to the base so that a distal end of the arm can engage the leader pin and pull the magnetic tape out of the medium; and
a flange disposed between the base and the arm, the flange being arranged to surround an axis about which arm rotates.

11. The system of claim 10, wherein the flange is in direct contact with both the base and an underside of the arm.

12. The system of claim 10, wherein at all available positions of the arm during rotation, the arm is in contact with the flange.
